(19) United States
(12) Patent Application Publication
(10) Pub. No.: US 2017/0094899 A1
(43) Pub. Date: Apr. 6, 2017

(54) Header with Middle Belt and Additional Grain Loss Prevention Means

(71) Applicant: Carl Geringhoff GmbH & Co. KG, Ahlen (DE)

(72) Inventors: Dirk Webermann, Senden (DE); Stephan Schulze Selting, Enniger (DE); Michael Pokriefke, Hude (DE)

(21) Appl. No.: 15/286,579

(22) Filed: Oct. 6, 2016

(30) Foreign Application Priority Data
Oct. 6, 2015 (DE) 10 2015 116 951.7
Oct. 19, 2015 (DE) 10 2015 117 787.0

(51) Int. Cl. A01D 34/40; A01D 57/20; A01D 34/14; B65G 15/46

(52) U.S. Cl. CPC A01D 34/40; B65G 15/46; A01D 57/20; A01D 34/14; A01D 2101/00

(57) ABSTRACT

A header for harvesting agricultural crop is designed to be mounted on a harvesting machine and has a support frame with a cutter bar arranged on the front side and blades fastened thereto. Conveying elements for transporting away the cut stalk material include at least two belt conveyors conveying the crop transversely relative to the travel direction and a central belt conveyor as a middle belt that conveys counter to the travel direction. A drive drives the cutter bar and the conveying elements. In order to better protect the middle belt against grain losses over the lateral edge of the revolving belt, the middle belt has, at lateral edges on its outwardly pointing surface, a grain-blocking elevation, respectively.

### BACKGROUND OF THE INVENTION

The present invention relates to a header for agricultural crop, wherein the header is provided for mounting on a harvesting machine. The header comprises a support frame, a cutter bar arranged on the front side and having blades fastened thereto, and conveying elements for conveying away the cut stalk material. The conveying elements comprise at least two belt-type conveyors which convey the crop transversely with respect to the direction of travel of the header during harvest, and further comprise a centrally arranged belt-type conveyor as a middle belt, which conveys counter to the direction of travel of the header. Drive means for driving the cutter bar and the conveying elements are provided.

A header of the aforementioned kind is known from U.S. Pat. No. 7,444,798. The middle belt has, on its outwardly pointing surface, strips which are applied so as to be spaced apart from one another and which are obliquely inclined in trailing fashion toward the middle. The strips are intended to guide crop that is discharged onto the middle belt by the transversely conveying belt-type conveyors away from the lateral edges of the revolving middle belt toward the middle. This applies in particular to grain kernels, which are essential to the harvest yield but which can very easily roll away over the edges of the middle belt, and thus be lost in terms of the crop, in the event of shocks, wind, oblique positions of the header during harvesting, material accumulations and other disruptions in the harvesting process or material flow.

It has been found that the strips applied to the revolving middle belt are not sufficient to prevent grain losses over the lateral edges of the middle belt under all harvesting conditions. In particular in the case of difficult crop such as seeds of oilseeds, e.g. rapeseed, the grains continue to roll over the lateral edge despite the strips on the outwardly pointing surface of the middle belt. Here, a situation may arise in which the grains fall onto the inner side of the revolving belt, pass from there into the region of a deflecting roller of the middle belt, and are crushed there between the surface of the deflecting roller and the inner side of the revolving belt. The oil that emerges from the grains as a result adheres to the inner surface of the revolving belt and causes slippage of the driven deflecting roller on the inner side of the revolving belt, such that the belt no longer revolves in a correctly driven manner. The oil that adheres to the inner side of the revolving belt may furthermore become resinous in the air, and thereby cause the revolving belt to stick to the deflecting roller and give rise to vibratory, rough running of the revolving middle belt.

U.S. Pat. No. 7,182,202 discloses support parts fastened to edge-side belts of a belt-type conveyor for tubers. Upwardly projecting fingers formed on the support parts have an intermediate space between them. The support parts cannot be fastened to a middle belt because the belt material is too thin in relation to the conveyor belts. The support parts are also not flexible enough to revolve around the narrow deflecting rollers that are used in the case of belt-type conveyors, and in particular in the case of middle belts, over a relatively long period of time without sustaining damage. Furthermore, the intermediate spaces at the support parts are too large to be able to effectively retain grains.

Accordingly, it is the object of the present invention to protect the middle belt more effectively against grain losses over the lateral edge of the revolving belt.

### SUMMARY OF THE INVENTION

For a header of the aforementioned kind, the object is achieved in that the middle belt has, at its lateral edges on its outwardly pointing surface, in each case one grain-blocking elevation.

The grain-blocking elevation is effective in preventing grain kernels or the grains of oilseeds from rolling over the lateral edges of the middle belt. Owing to their relatively low weight, the grains exhibit only low kinetic energy when they move on the surface of the middle belt transversely or obliquely with respect to the conveying direction of the middle belt. Elevations on the lateral edges have the effect that, when grains strike the side surfaces of the elevations, the grains are stopped in terms of their movement and move no further toward the lateral edge of the revolving belt.

The grain-blocking elevations are formed along the full length of the edges of the middle belt in order to prevent grain losses during a full revolution of the middle belt.

The grain-blocking elevations do not need to be of a large height in order to prevent the major part of the grain losses caused by grains falling laterally from the middle belt. A height of 0.5 cm over the outwardly pointing surface of the revolving belt is sufficient to stop many of the grains moving toward the lateral edge. A greater height self-evidently increases the proportion of grains that are intercepted.

The elevations may be cast directly into the material of the revolving belt if the revolving belt is produced in a casting tool. It is however also possible for molded parts which form the grain-blocking elevations to be applied to the material of the middle belt and fastened there, for example, by adhesive bonding, vulcanization, riveting or other suitable fastening techniques.

The grain-blocking elevations may be of continuously closed form over their entire height and width toward the belt surface. In the case of an excessively large height of the elevations, however, a situation arises in the region of the deflecting rollers in which the flexing work in the material of the elevations is so intense that the elevations can detach from the material of the revolving belt. By way of a restriction of the height of the elevations to a suitable dimension and an adaptation of the material used for the elevations to the flexing work and the temperatures that arise in the material as a result, and the use of a suitable fastening means for the elevations if the elevations are applied retroactively to the material of the revolving belt, it is possible to realize a still satisfactory service life of the elevations.

In one embodiment of the invention, the grain-blocking elevation has, over its length, a lateral offset transversely with respect to the direction of rotation of the middle belt. The lateral offset may be formed by virtue of the elevation being laid for example in loops. Sections of the grain-blocking elevation laid in loops are partially or predominantly oriented in the transverse direction with respect to the direction of revolution. Thus, during revolution about a deflecting roller, the material of the loops of the grain-blocking elevation is itself subjected to less intense tensile load in these sections than other sections of the grain-blocking elevation, which extend substantially or entirely in the direction of revolution of the middle belt. The material of the grain-blocking elevation thus forms, in the region of the loops, a material reserve for sections of the material of the grain-blocking elevation that are subjected to relatively intense tensile load. The material reserve can thus accommodate a part of the tensile loads that act on those sections which are oriented more in the direction of revolution, and can thereby reduce the average tensile load. During revolution about a deflecting roller, the tensile loads acting on the outer regions of the material of the grain-blocking elevation are thus lower, whereby the service life of the grain-blocking elevation and of the middle band is altogether greatly increased. The lateral offset of the grain-blocking elevation transversely with respect to the direction of rotation of the middle band however need not be implemented in loop form; a jagged profile in zigzag form or a profile with undulating patterns or other configurations are possible, for example.

In one embodiment of the invention, the grain-blocking elevations are formed with incisions, notches or free spaces which are oriented obliquely or transversely with respect to the conveying direction of the revolving belt and which extend over a part of the height or over the full height of the elevations. The incisions, notches or free spaces reduce the flexing work in the material of the elevations. Without the incisions, notches or free spaces, the material of the elevations will, during revolution about a deflecting roller, be stretched and compressed with increasing intensity in an outward direction over the height of the material, over the radius which becomes greater with increasing height, over the revolving length of the elevation. To the depths to which the incisions, notches or free spaces extend, the material of the elevations can now pivot forward in blockwise fashion during revolution about the deflecting roller, without pulling the material of an adjacent block of the elevation along with it, such that, during revolution about the deflecting roller, the incisions, notches or free spaces open in V-shaped and scissor-like fashion, and close again back into the initial position.

This effect can also be utilized for carrying along crop that falls onto the edge region of the middle belt. Such crop can at least partially fall into the incisions, notches or free spaces and be clamped there by the material. Held clamped in the incisions, notches and free spaces, the crop is then carried along in the conveying direction of the middle belt to the deflecting roller, where the incisions, notches or free spaces open in scissor-like fashion, and the crop that is held clamped is thereby released. In this way, the crop can then be moved further in the desired conveying direction away from the middle belt.

The notches may be formed as simple incisions or cutouts into the material of the elevations. The notches may however also be in the form of a free space which is formed between adjacent material blocks of the elevations. The shape, depth and width of the notches or of the free space should in this case be adapted to the crop that is intended to be restrained by the elevations. Excessively large free spaces lead to grain losses.

In one embodiment of the invention, multiple rows of grain-blocking elevations are arranged adjacent to one another in the longitudinal direction of the middle belt, which rows are separated from one another by incisions, notches or free spaces which extend at least substantially in the longitudinal direction of the middle belt. By way of multiple rows of grain-blocking elevations, the blocking action of the elevations formed at the edge of the middle belt can be increased. This applies in particular if, in the elevations, there are provided notches or free spaces which are narrowed or covered entirely by elevations of an adjacent row in the transverse direction.

In one embodiment of the invention, the rows of grain-blocking elevations have incisions, notches or free spaces which are oriented obliquely or transversely with respect to the conveying direction of the revolving belt and which are formed offset with respect to one another in the transverse direction of the middle belt. The individual blocks of the rows of elevations are thus arranged in staggered fashion, such that a grain can no longer roll through the incision, the notch or the free space between two adjacent blocks of a row, but rather is stopped at the latest by the staggered block of an adjacent row.

In one embodiment of the invention, the elevations are produced from an elastomer material. Owing to the elastomer material, the elevations have the elasticity required to be able to deform during revolution about the deflecting rollers.

In one embodiment of the invention, the grain-blocking elevations are composed of multiple mutually adjacently arranged rows of molded bodies, the molded bodies having in each case a spacing to the next molded body in the direction of the row, and the rows being arranged in staggered fashion with respect to one another. Such an arrangement offers a good compromise between durability and longevity of the elevation and the blocking action for prevention of grain losses.

In one embodiment of the invention, the molded bodies have a cylindrical basic shape.

In one embodiment of the invention, strips are applied to the outwardly pointing surface of the middle belt, which strips extend substantially transversely with respect to the conveying direction of the middle belt and have an undulating shape over their extent transversely across the middle belt. The strip of undulating shape has the advantage, during the revolution of the middle belt about the deflecting rollers, that the material of the strip can, in the case of corresponding elasticity of the material, pull material out of regions of the strip that are not yet situated in the region of action of the deflecting roller.

In one embodiment of the invention, the amplitude of the undulating shape of the strips applied to the outwardly pointing surface of the middle belt is greater than half of the circumference of a deflecting roller of the middle belt. By way of this amplitude height, it is ensured that, during revolution about a deflecting roller, the strip is not situated entirely in the region of action of the deflecting roller.

It is expressly pointed out that the embodiments of the invention described above are combinable in each case individually, but also in any desired combinations with one another, with the subject matter of the main claim, as long as there are no technical constraints preventing this.

Further modifications and embodiments of the invention will emerge from the following description of the subject matter and from the drawings.

### BRIEF DESCRIPTION OF THE DRAWINGS

The invention will now be discussed in more detail on the basis of exemplary embodiments.

FIG. 1 shows a partial view of a middle belt in a view obliquely from the front.

FIGS. 2a, 2b, and 2c show views of an alternative embodiment with a lateral grain-blocking elevation arranged in loops.

FIG. 3 shows purely schematically a header with drive, transverse conveyors and middle belt, and cutter bar on a support frame.

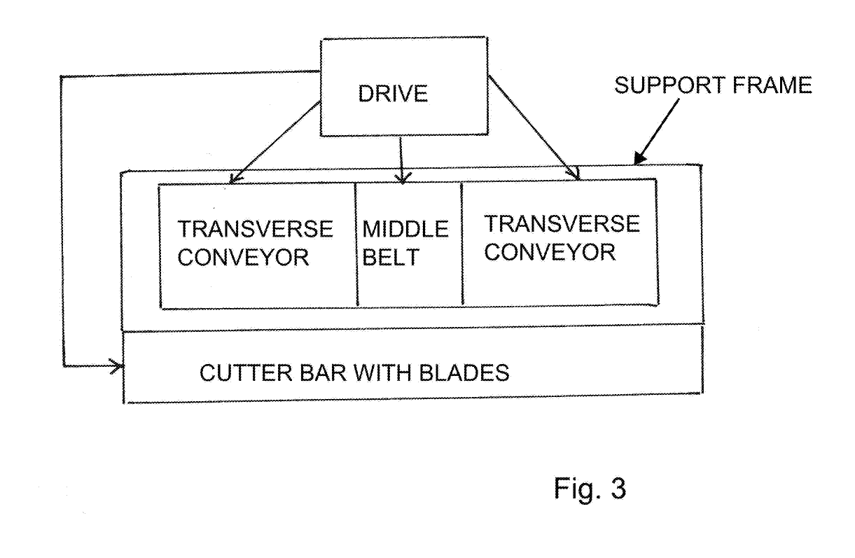

### DESCRIPTION OF PREFERRED EMBODIMENTS

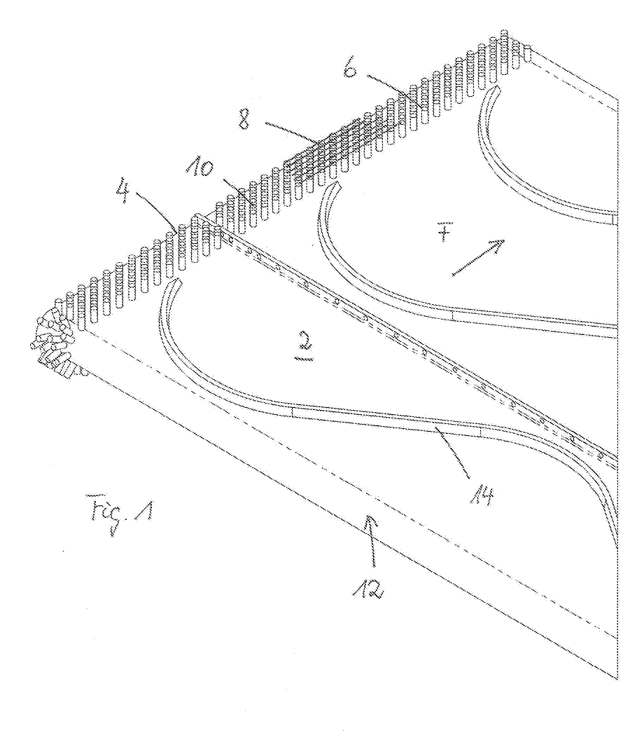

FIG. 1 shows a partial view of a middle belt in a perspective front view.

FIG. 1 shows a detail of a middle belt 2 in a perspective view from above. The middle belt 2 is driven in continuous circulating fashion in a conveying direction F, counter to the direction of travel of the harvesting machine into the standing crop. The middle belt 2 has lateral edges 4. In a draper header, the cut crop is conveyed to the middle belt 2 by lateral belt-type conveyors which discharge the crop past the lateral edges 4 onto the top side of the middle belt 2.

FIG. 1 shows six rows 8 of elevations 6 on the lateral edge 4 of the middle belt 2. In the embodiment, the elevations 6 are composed of molded bodies 10 which have a cylindrical basic shape. The molded bodies 10 are lined up with one another at uniform intervals. The rows 8 are offset with respect to one another in staggered fashion such that the molded bodies 10 of one row cover in a transverse direction a gap between the molded bodies 10 of an adjacent row, respectively.

In the exemplary embodiment shown in FIG. 1, the gaps or the free spaces have a width slightly greater than the diameter of a molded body 10. The gaps 10 may however also be smaller, and may even be narrowed to form a slot between adjacent material blocks of an elevation, which slot opens in scissor-like fashion only in the region of deflection of the middle belt about a deflecting roller 12, as can also be seen in FIG. 1 in the region of deflection for the molded bodies 10.

The gaps or free spaces shown in FIG. 1 extend from the top side of the molded parts 10 to the outwardly pointing surface of the middle belt 2. By contrast to this, it is also possible for the gaps to extend to a lesser depth by virtue of the base regions of the gaps in the region of the elevation 6 protruding above the outwardly pointing surface of the middle belt 2.

To the outwardly pointing surface of the middle belt there are applied strips 14 which extend substantially transversely with respect to the conveying direction of the middle belt and which have an undulating shape over their extent transversely across the middle belt. The amplitude of the undulating shape of the strips applied to the outwardly pointing surface of the middle belt is greater than half of the circumference of a deflecting roller of the middle belt.

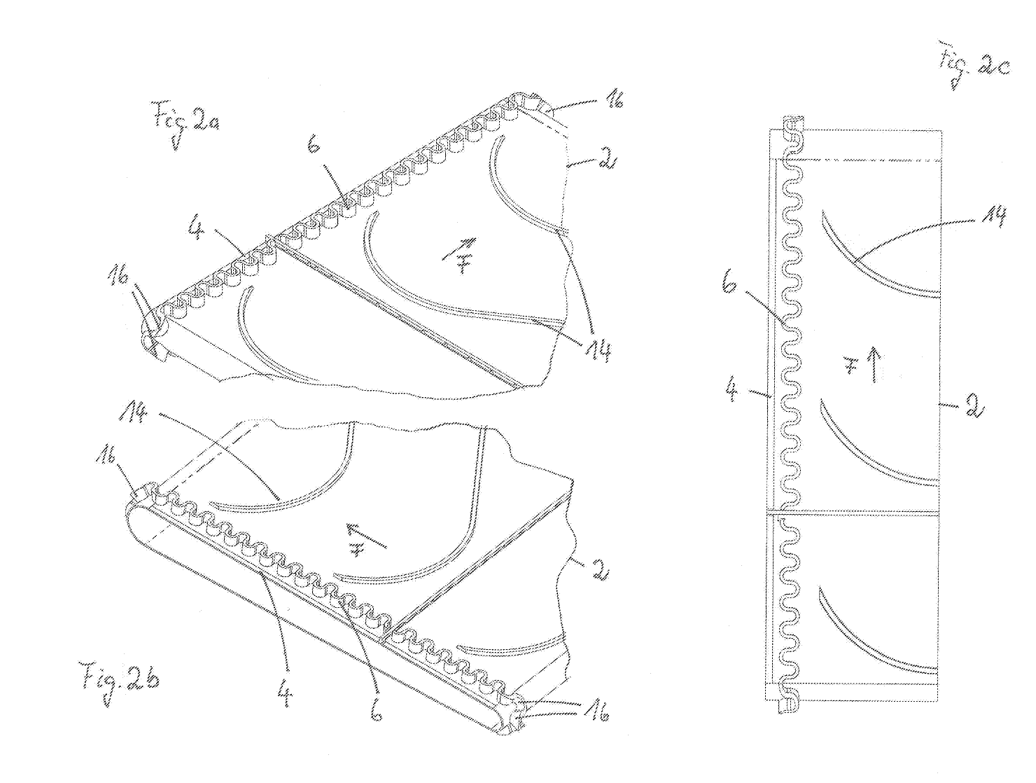

FIGS. 2a, 2b, and 2c show views of an alternative embodiment with a lateral grain-blocking elevation 6 arranged in loops. The grain-blocking elevation 6 shown in FIGS. 2a, 2b, and 2c is laid in loops and has, over its length, a lateral offset transversely with respect to the conveying direction (direction of rotation) of the middle belt 2. Those sections of the lateral grain-blocking elevation 6 which are subjected to tensile load in the conveying direction (direction of revolution) F can pull material which is not subjected to tensile load, or which is subjected to only a very low tensile load, out of the material of the sections laid in loops. This can be seen in the regions in which the middle belt 2 is deflected about the deflecting rollers. Thus, it is possible to see regions 16 of the elevation 6 that have been stretched in the region of the deflecting rollers, in which regions the material of the elevation 6 has been pulled longitudinally and, here, material from the loop has been utilized in the conveying direction (direction of revolution) F for the flexible change in length of the elevation 6. In this way, the material of the lateral elevations 6 is altogether greatly protected against stress forces and relieved of load; this significantly increases the service life of the material of the grain-blocking elevations 6.

The invention is not restricted to the embodiments above. It poses no difficulties to a person skilled in the art to modify the embodiments in a manner that would appear suitable to him or her in order to adapt it to a specific usage situation.

The specification incorporates by reference the entire disclosure of the two German priority documents 10 2015 116 951.7 having a filing date of Oct. 6, 2015, and 2015 117 787.0 having a filing date of Oct. 19, 2015.

While specific embodiments of the invention have been shown and described in detail to illustrate the inventive principles, it will be understood that the invention may be embodied otherwise without departing from such principles.

What is claimed is:

1. A header for agricultural crop for attachment to a harvesting machine, the header comprising:
a support frame;
a cutter bar arranged on a front side of the support frame and comprising blades fastened to the cutter bar;
conveying elements for transporting away cut crop, the conveying elements including at least two belt conveyors conveying the cut crop in a transporting direction transverse to a travel direction of the header during harvesting and further including a centrally arranged belt conveyor as middle belt transporting the cut crop in a conveying direction counter to the travel direction;
a drive drivingly connected to the cutter bar and the conveying elements;
wherein the middle belt comprises an outwardly pointing surface with lateral edges and further comprises grain-blocking elevations arranged on the lateral edges.

2. The header as claimed in claim 1, wherein the grain-blocking elevations each have, across a length thereof, a lateral offset in a direction transverse to a direction of rotation of the middle belt.

3. The header as claimed in claim 1, wherein the grain-blocking elevations comprise incisions, notches, or free spaces which are oriented obliquely or transversely relative to the conveying direction of the middle belt and which extend over a part of a full height, or across the full height, of the grain-blocking elevations.

4. The header as claimed in claim 1, wherein multiple rows of the grain-blocking elevations are arranged adjacent to one another in a longitudinal direction of the middle belt, wherein the rows of the grain-blocking elevations are separated from one another by incisions, notches or free spaces and the incisions, notches or free spaces extend at least substantially in a longitudinal direction of the middle belt.

5. The header as claimed in claim 4, wherein the rows of the grain-blocking elevations have incisions, notches or free spaces which are oriented obliquely or transversely to the conveying direction of the middle belt and are formed offset relative to one another in a transverse direction of the middle belt.

6. The header as claimed in claim 1, wherein the grain-blocking elevations are comprised of an elastomer material.

7. The header as claimed in claim 1, wherein the grain-blocking elevations are comprised of multiple mutually adjacently arranged rows of molded bodies, the molded bodies each having a spacing to the next molded body in a row extension direction of the rows, respectively, and the rows are staggered relative to each other.

8. The header as claimed in claim 7, wherein the molded bodies have a cylindrical basic shape.

9. The header as claimed in claim 1, further comprising strips applied to the outwardly pointing surface of the middle belt, wherein the strips extend substantially transversely relative to the conveying direction of the middle belt and have an undulating shape across a length thereof in a transverse direction of the middle belt.

10. The header as claimed in claim 9, wherein an amplitude of the undulating shape of the strips is greater than half of a circumference of a deflecting roller of the middle belt.
